(19) United States
(12) Patent Application Publication
(10) Pub. No.: US 2020/0391677 A1
(43) Pub. Date: Dec. 17, 2020

(54) ADVERTISING AND DECORATIVE LICENSE PLATE FRAME SYSTEM

(71) Applicant: Jason Nole, Auburn, CA (US)

(72) Inventor: Jason Nole, Auburn, CA (US)

(21) Appl. No.: 16/442,482

(22) Filed: Jun. 15, 2019

(51) Int. Cl. B60R 13/10; B60Q 1/56; G09F 7/06; G09F 13/04

(52) U.S. Cl. CPC B60R 13/105; B60Q 1/56; G09F 21/04; G09F 13/0413; G09F 7/06

(57) ABSTRACT

A advertising and decorative license plate frame system employ methods to personalize license plates, such as through the use of illumination or graphics design for use with a vehicle such as an automobile, truck, motorcycle, or the like. The present invention includes a back plate and a front cover shaped to surround the perimeter of a standard license plate without covering identifying numbers or letters of the plate indicia. The front cover is typically a sheet having a surface area with a 3D raised imprint and/or printed indicia including pictures and/or text. The back plate whereas the lighting assembly is typically mounted and within the illumination frame housing to illuminate embossed figures or symbols on the exterior of the front cover. The lighting assembly preferably includes a plurality of light emitting diodes (LEDs) electrically connected via wires to an electrical power source (such as the vehicle's battery).

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates generally to a advertising and decorative license plate frame system, and more particularly, a license plate frame system configured to provide space for advertising and other indicia thereon without obscuring the information displayed on the license plate.

### BACKGROUND OF THE INVENTION

Every motor vehicle is generally required to have at least a license plate mounted at the front or rear of the vehicle. Typically, a license plate holder is placed in the front of the vehicle affixed to the front bumper. Similarly, if a license plate is to be placed at the rear of the vehicle, it is affixed to the rear bumper. The license plate and license plate holder becomes the first point of contact when the vehicle bumped into or by another vehicle or an object.

Additionally, some license plate holders comprise advertising material or other indicia thereon, such as university names, vehicle dealership names, sports team names and logos, among others. However, conventional license plate holders do not provide much room for advertising materials and indicia to be printed thereon, and as a result the advertising material may be small and not readily viewable by third parties. Some license plate holders include special regions for advertising materials, but such regions may obscure or cover part of the license plate. Covering information on the license plate is undesirable and may result in the driver violating a traffic regulation and receiving a fine.

In the automobile industry, the use of badges (i.e., emblems, trademarks, trade names, insignia, logos, designs or the like) has become a common way to decorate and mark a vehicle. Newly manufactured vehicles almost always include exteriorly mounted badges (e.g., on doors, bumpers, panels, or the hood) and/or interiorly mounted badges (e.g., on the dashboard or airbag covers). Three-dimensional badge designs are increasingly popular, as the raised indicia enhances aesthetic appeal overall.

One type of common advertising device is an adhesive advertisement structured to be applied to a flat surface, such as an automobile. Typically the adhesive advertisement is applied to a bumper and is commonly, and hereinafter, identified as a “bumper sticker.” The bumper sticker may, of course, be applied to any surface such as, but not limited to, walls, notebook covers, luggage, displays, or other vehicles.

Devices have been disclosed in the prior art that relate to license plate holders. These include devices that have been patented and published in patent application publications. These devices generally relate to license plate covers having means for carrying advertising materials, such as U.S. Pat. No. 2,093,620, 2,815,598, U.S. Design Patent Number D1 75,144, U.S. Pat. No. 2,618,089, and U.S. Published Patent Application Number 2006/0075665.

These prior art devices have several known drawbacks. The license plate holders in the prior art provide frames having areas for advertising materials, wherein the additional areas extend outwardly from an upper portion of the frame. As a result, the license plate holder does not include the traditional rectangular shape, and instead includes a protrusion from a portion thereof that may be undesirable or aesthetically unappealing. Further, some license plate holders provide advertising space that covers or obscures portions of the license plate, which is also undesirable. Thus, the devices in the prior art fail to provide a license plate holder having an enlarged area on the lower end thereof that extends below the lower end of a license plate held therein so as to provide space for advertising materials without obscuring the license plate.

Along with vanity license plates, decorative license plate frames or holders are popular amongst car enthusiasts as well as those wishing to make a statement or to have a decorative element on their vehicle. Currently, there are available a number of decorative license plate frames on which stock and/or customized lettering and designs may be placed. For example, rigid or semirigid plastic strips having engraved lettering may be adhered onto the face surface of a metal license plate frame. Alternatively, lettering may be engraved into a sufficiently rigid license plate frame. Stamped metal license plate frames having one or more epoxy color coatings are also available. Each of these existing types of license plate frames, however, have limited decorative flexibility with the engraved and/or stamped designs being fairly simple and having one or few colors for manufacturing ease as well as reasonable cost of production.

Although it is known to employ various methods to personalize license plates, such as through the use of illumination or graphic design, an apparatus that allows figures or symbols on the exterior of the frame to become illuminated and/or otherwise visible on or from the sides of the license plate, without obscuring the face of the license plate, does not currently exist.

There remains a need therefore for an economical advertising and decorative license plate frame system for illuminating and personalizing decorative license plate that does not obscure the face of the plate having great design flexibility and a license plate frame having space for advertising material thereon without obscuring the information on the license plate is desired. The present novel technology addresses this need.

### BRIEF SUMMARY OF THE INVENTION

The primary object of the present invention is to employ methods to personalize license plates, such as through the use of illumination or graphics design, an apparatus that allow figures or symbols on the exterior of the frame to become illuminated and/or otherwise visible on or from the sides of the license plate, without obscuring the face of the license plate.

The present invention provides a new advertising and decorative license plate frame system wherein the same can be utilized for providing convenience for the user when providing license plate frame having space for advertising materials or other indicia whereon the plate is quickly interchangeable to suit an individual's aesthetic needs. More-over, the device is adapted to enhance visibility at night, provides a means of advertising for companies and is wired into the headlight system of a motor vehicle.

A advertising and decorative license plate frame system made of a tough, resilient material has a back support with walls extending from the back support along the perimeter, defining a thick border and a well for mounting a license plate. The height of the walls is higher than the thickness of the license plate to provide adequate protection of the license plate mounted therein.

The advertising and decorative license plate frame system holder includes a frame formed with a peripheral dent for receiving a license plate and that can be secured thereto. The frame is substantially rectangular in configuration and includes a first side, a second side, an upper end, and a lower end defining a central opening. The lower end of the frame extends below the license plate held therein and includes an enlarged area for advertising material. The license plate advertising display frame further includes a plurality of openings adapted to align with openings on the license plate for securing the license plate holder thereto via fasteners, such as screws.

A advertising and decorative license plate frame system frame having an enlarged area for advertising material and other indicia may optionally include decorative component including three-dimensional and/or multi-colored decorative elements and/or space upon which decals, stickers, labels, placards, or similar items may be placed.

### BRIEF DESCRIPTION OF THE DRAWING

FIG. 1 Display a view of one possible embodiment advertising and decorative license plate frame system of the present novel technology mounted on the rear of a vehicle.

FIG. 2 is a front perspective view of a advertising and decorative license plate frame system according to a first embodiment of the present invention.

FIG. 3 is an exploded side perspective view of the embodiment of FIG. 2

FIG. 4 is a front elevation view of a second embodiment illumination frame housing of the present novel technology.

FIG. 5 is an exploded perspective view of the illumination frame housing of FIG. 5.

FIG. 6 is a rear partial perspective view of the illumination frame housing of FIG. 5.

FIG. 7 is a front elevation schematic view of a third embodiment license plate frame system of the present novel technology.

FIG. 8 is a first front elevation view of the system of FIG. 7 showing a first projected image.

FIG. 9 is a second front elevation view of the system of FIG. 7 showing a second projected image.

### DESCRIPTION OF CERTAIN EMBODIMENT OF THE PRESENT INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

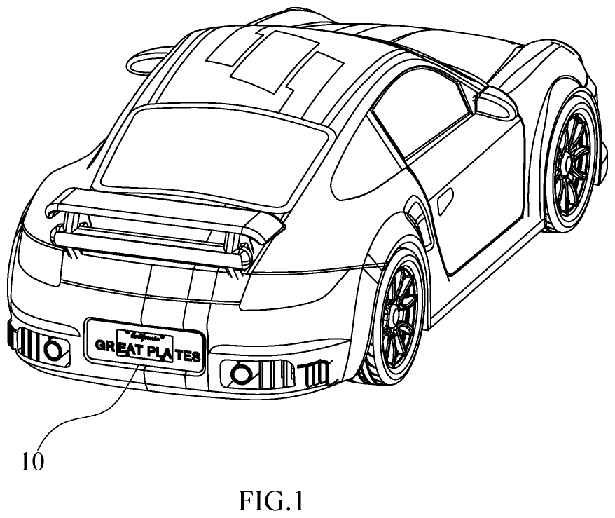

FIG. 1, illustrates a first embodiment of the present novel technology, an advertising and decorative license plate frame system 10 for use with a vehicle such as an automobile, truck, motorcycle, or the like. The front portion advertising and decorative license plate frame system 10 may alternately include preprinted, embossed, illuminated or painted visual materials.

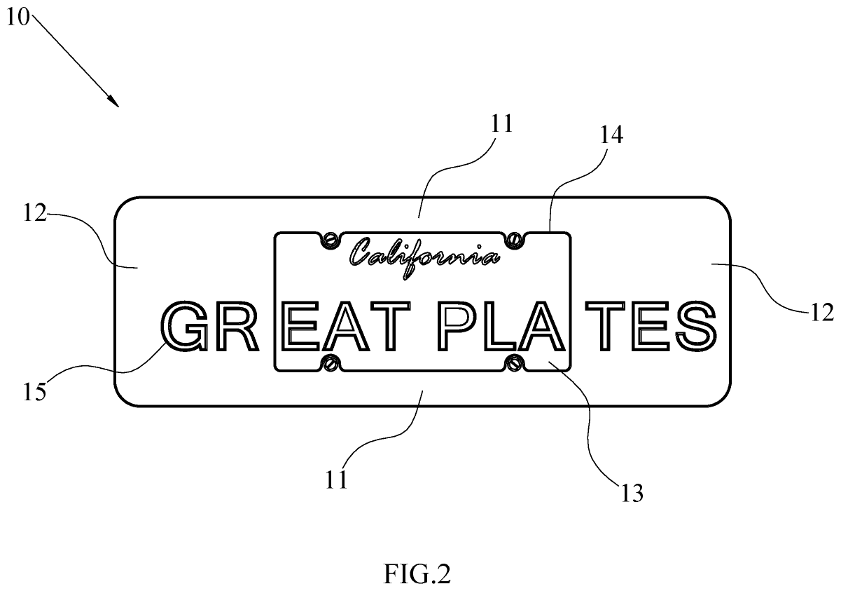

As generally shown in FIG. 2 is a front view of the license plate frame system 10 preferably, rectangular having two generally parallel long sides 11 and two generally parallel short sides 12 including a central opening 13 for receiving a license plate 14. The license plate frame system is typically a sheet having a first side with a 3D raised imprint 15 and/or printed indicia including pictures and/or text, (although any design, symbol, or shape may be utilized) and a second side having an adhesive applied thereto.

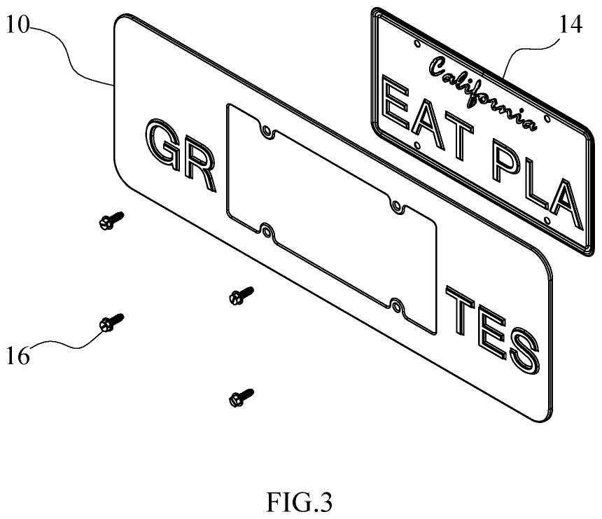

As shown in FIG. 3, an exploded view of the advertising and decorative license plate frame system 10 showing the relationship between the major components including the license plate 14, and the license plate mounting screws 16.

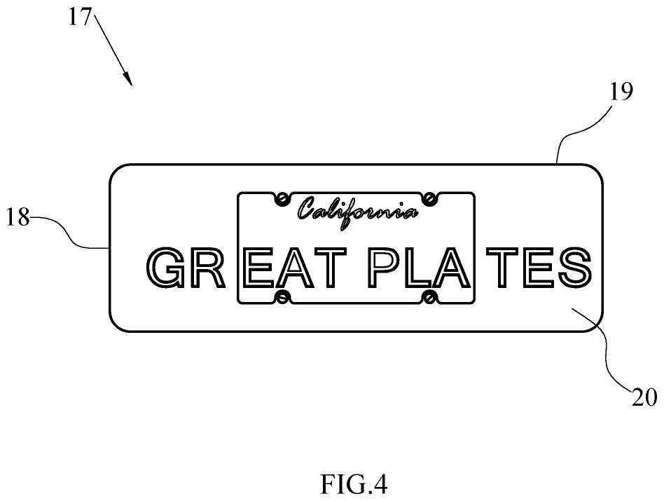

FIG. 4 is a front view of the second embodiment advertising and decorative license plate frame system 10 provides an interchangeable license plate frame system 17 with a backlight illumination frame housing 18. The device comprises a rectangular housing, made from plastic or other suitable material, which attaches to the rear of an automobile. The backlight illumination frame housing 18 generally includes a back plate 19, and a front cover portion 21 typically made of a suitable lightweight plastic or metal, and generally shaped to surround the perimeter of a standard license plate (although any shape or size may be utilized) without covering identifying numbers or letters of the plate indicia.

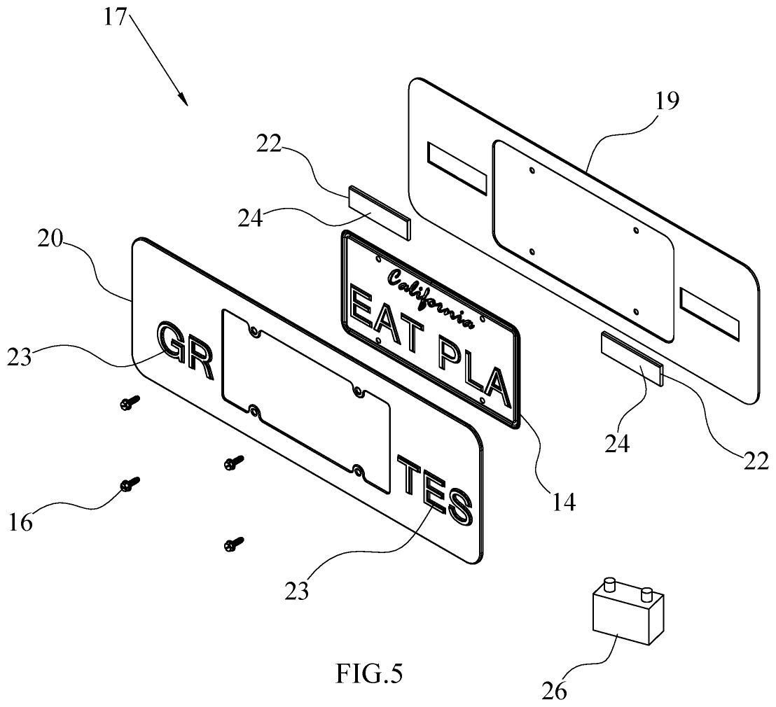

FIG. 5 is an exploded view of the construction second embodiment advertising and decorative license plate frame system 10, shown in FIG. 4. The present invention includes a back plate 19 whereas the lighting assembly 22 is typically mounted and within the illumination frame housing 17 to illuminate embossed figures or symbols 23 on the exterior of the front cover 20. The lighting assembly 22 preferably includes a plurality of light emitting diodes (LEDs) 24 electrically connected via wires 25 to an electrical power source 26 (such as the vehicle's battery).

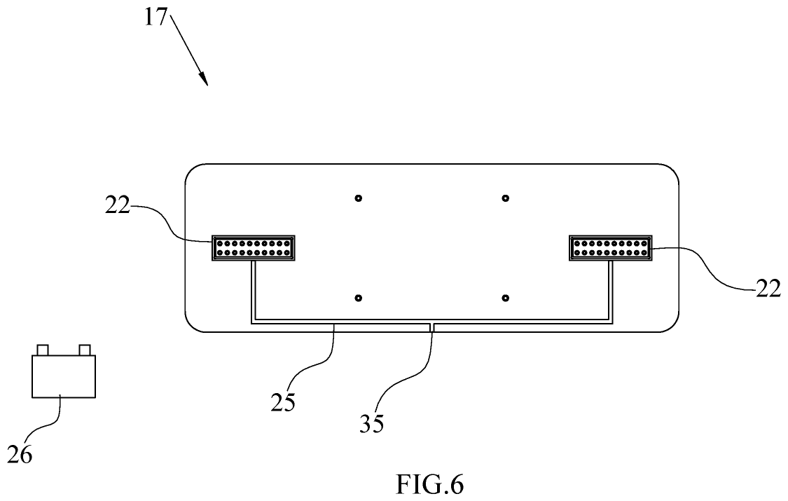

As generally shown in FIG. 6 is a rear view of the illumination frame housing 17 showing the location of the lighting assembly 22 may be connected directly to a motor vehicle's electrical system 26 or other electrical source using wires 25 and the connectors 35. Advantageously, the use of LEDS is significantly more energy efficient and lighting efficient than the standard incandescent lamps that are used in most vehicles today. The LEDS not only use less energy but also generate significantly less heat.

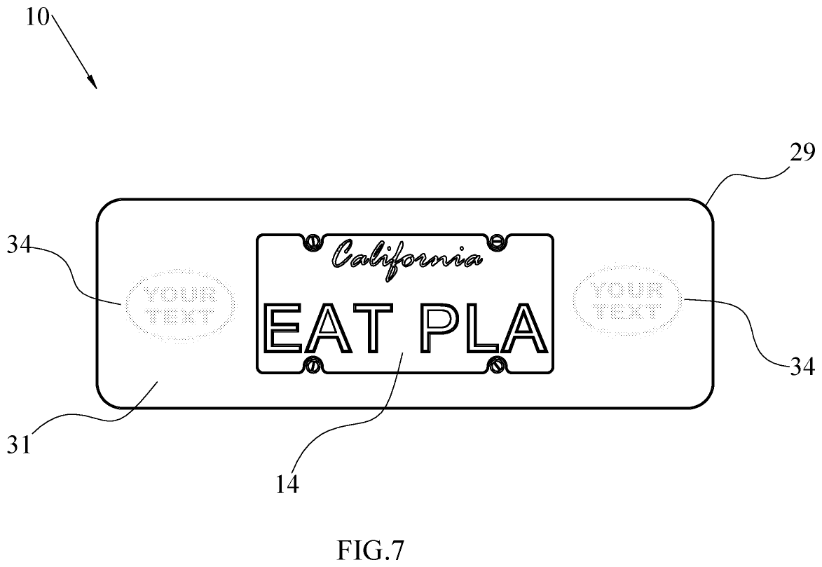

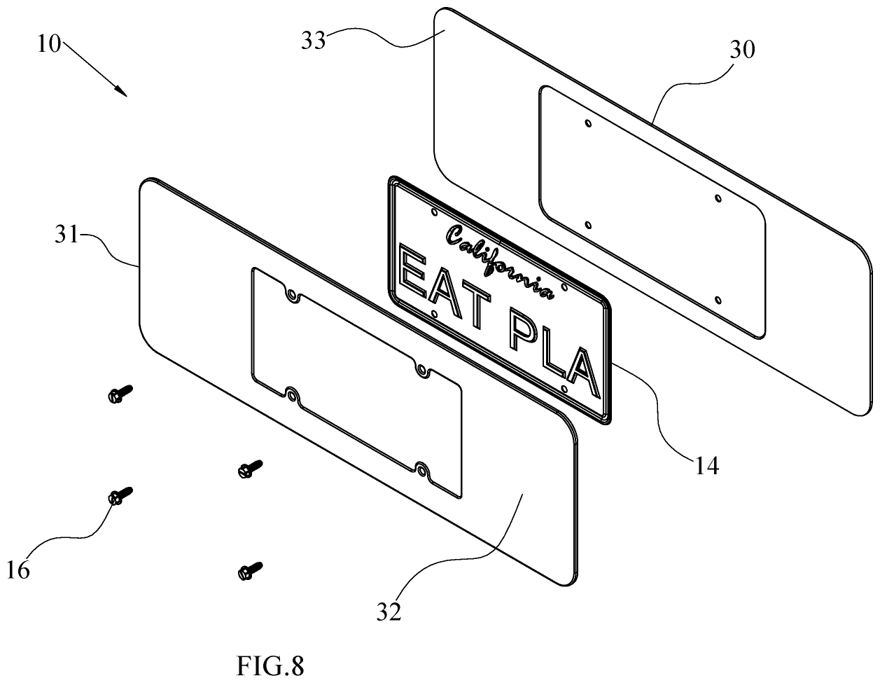

In another embodiment, as illustrated in FIGS. 7-8, an advertising and decorative license plate frame system 10 having one or more advertising surfaces extending there from. The blank frame assembly 29 generally includes a back plate 30 and a front cover portion 31 which is typically made of a suitable lightweight plastic or metal, and generally shaped to surround the perimeter of a standard license plate 14 (although any shape or size may be utilized) and define a display window 32 without covering identifying numbers or letters of the plate indicia. The assembly further includes fasteners 33 to securely and removable connect the back plate 30 and the front cover portion 31. The front cover portion 31 is typically flat for receiving advertising information, such as a decal or other illustration. The front cover portion 31 is structured to be a printable surface upon which an indicia 34, such as, but not limited to, pictures and text may be printed, painted, or otherwise applied, which hereinafter will be identified as printed.

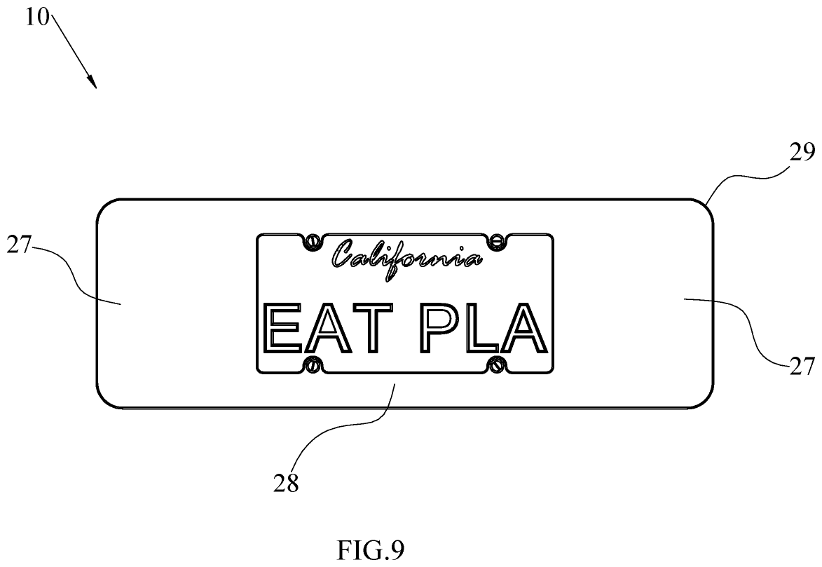

As shown in more detail in FIG. 9 is a front elevation The blank frame assembly 29 includes a programmable LCD or like screen 27, which is operationally connected with a microprocessor 28 such as by a remote connection to receive and display static or moving images.

1. A license plate frame system, comprising:
an interchangeable frame system that includes:
a back plate;
a front cover shaped to surround a perimeter of a standard license plate without covering identifying numbers or letters of plate indicia of the standard license plate, the front cover having an enlarged area for advertising and decorative material, the advertising and decorative material of the front cover including, a textual or design extension of the plate indicia of the standard license plate, the front cover including a frame, the frame having:
a first side;
a second side;
an upper end; and
a lower end; and
at least one frame opening adapted to align with at least one corresponding standard license plate opening on the standard license plate for securing the frame thereto via fasteners.

2. The license plate frame system of claim 1, wherein the back plate is formed with a peripheral dent for receiving the standard license plate, the peripheral dent extending around a back side of the standard license plate.

3. The license plate frame system of claim 1, wherein the front cover having the enlarged area for advertising and decorative material is structured with a 3D raised imprint and/or printed indicia including pictures and/or text.

4. The license plate frame system of claim 1, further comprising a light source that is positioned behind the front cover and operates to transmit light through the front cover when illuminated.

5. The license plate frame system of claim 4, wherein the light source is connectable to a vehicle's lights in a manner that the light source is activated when the vehicle's lights are activated.

6. The license plate frame system of claim 1, further comprising at least one license plate frame system fastener that securely and removably connects the back plate and the front cover.

7. The license plate frame system of claim 1, wherein:
the advertising and decorative material of the front cover includes at least one letter that alone does not form a complete word;
the indicia of the standard license plate includes at least one letter that alone does not form a complete word; and
when combined, the at least one letter of the advertising and decorative material front cover and the at least one letter of the indicia of the standard license plate collectively form at least one complete word.

8. The license plate frame system of claim 1, wherein the advertising and decorative material of the front cover provides a design extension to the plate indicia of the standard license plate.

9. The license plate frame system of claim 8, wherein the design extension of the plate indicia of the standard license plate includes a textual extension.

10. The license plate frame system of claim 9, wherein the textual extension of the plate indicia of the standard license plate by the advertising and decorative material of the front cover includes a completion of at least one word.

11. The license plate frame system of claim 9, wherein the textual extension of the plate indicia of the standard license plate by the advertising and decorative material of the front cover includes a completion of two words, a first word completed by the letters displayed on a left side of the front cover in combination with the plate indicia of the standard license plate, and a second word completed by letters displayed on a right side of the front cover in combination with the plate indicia of the standard license plate.

12. The license plate frame system of claim 9, wherein the textual extension of the plate indicia of the standard license plate by the advertising and decorative material of the front cover includes letters displayed by the advertising and decorative material of the front cover having a same letter size as letters of the plate indicia of the standard license plate.

13. The license plate frame system of claim 9, wherein the textual extension of the plate indicia of the standard license plate by the advertising and decorative material of the front cover includes letters having a same font as letters of the plate indicia of the standard license plate.

14. The license plate frame system of claim 8, wherein the design extension to the plate indicia of the standard license plate extends immediate adjacent to the plate indicia of the standard license plate.

15. The license plate frame system of claim 8, wherein the design extension to the plate indicia of the standard license plate extends horizontally from the plate indicia of the standard license plate across the enlarged area of the front cover.

16. The license plate frame system of claim 15, wherein the design extension to the plate indicia of the standard license plate extends horizontally from both a left side and a right side of the plate indicia of the standard license plate across the enlarged area of the front cover.

17. The license plate frame system of claim 1, wherein the front cover is shaped to surround the perimeter of the standard license plate, and an outer periphery of the front cover is shaped according to a recessed license plate mounting surface of a car bumper.

18. The license plate frame display system of claim 1, wherein front over does not extend over the standard license plate, and the back plate extends entirely behind a back surface of the standard license plate.

19. The license plate frame system of claim 1, further comprising the standard license plate secured to the front cover of the interchangeable frame system of the license plate frame system, the standard license plate including one or more partial words and the front cover of the interchangeable frame system including one or more partial words, wherein the one or more partial words of the standard license plate in combination with the one or more only partial words of the front cover display one or more complete words when the standard license plate is secured to the front cover.

20. A license plate frame system, comprising:
an interchangeable frame system that includes:
a back plate; and
a front cover shaped to surround a perimeter of a standard license plate without covering identifying numbers or letters of plate indicia of the standard license plate, the front cover having an enlarged area for advertising and decorative material, the enlarged area for advertising and decorative material extending at least 3 inches beyond the edges of the standard license plate.

21. A license plate frame system according to claim 20, wherein the enlarged area for advertising and decorative material extending at least 4 inches beyond the edges of the standard license plate.

22. A license plate frame system according to claim 20, wherein the enlarged area for advertising and decorative material, the advertising and decorative material of the front cover including a textual or design extension of the plate indicia of the standard license plate.

23. A license plate frame system, comprising:
an interchangeable frame system that includes:
a back plate;
a front cover shaped to surround a perimeter of a standard license plate without covering identifying numbers or letters of plate indicia of the standard license plate, the front cover having an enlarged area for advertising and decorative material, the enlarged area for advertising and decorative material including a programmable display screen operationally connected with a microprocessor to receive and display static or moving images.
